(19) United States
(12) Patent Application Publication
(10) Pub. No.: US 2024/0334153 A1
(43) Pub. Date: Oct. 3, 2024

(54) END OF LINE TESTING FOR TRACKING TAGS

(71) Applicant: X Development LLC, Mountain View, CA (US)

(72) Inventors: Ricky Yik Hei Ngan, Mountain View, CA (US); Robert Shone, San Francisco, CA (US); Brion Koprowski, Boulder, CO (US); Russell Shikami, Cupertino, CA (US); Dean Kawaguchi, San Jose, CA (US)

(21) Appl. No.: 18/615,564

(22) Filed: Mar. 25, 2024

Related U.S. Application Data
(60) Provisional application No. 63/456,220, filed on Mar. 31, 2023.

(51) Int. Cl. H04W 4/02; H04W 4/80; H04W 12/037

(52) U.S. Cl. CPC H04W 4/02; H04W 4/80; H04W 12/037

(57) ABSTRACT

Aspects of the disclosure provide for testing of tracking tags. Tracking tags may include circuitry configured to operate in a normal operating mode for sending first beacon signals to enable the tracking of objects, and to operate in a testing mode for sending second beacon signals to enable testing of the tracking tag. A testing system may include a reader including an antenna configured to receive one or more beacon signals. The example system may also include one or more computing devices having one or more processors and being in communication with the reader. The one or more computing devices may also be configured to induce a tracking tag to generate the one or more beacon signals in a testing mode, the one or more beacon signals including an encrypted or unencrypted payload. The system may use the payload to determine whether to mark the tracking tag to be discarded.

### CROSS REFERENCE TO RELATED APPLICATIONS

This application claims the benefit of the filing date of U.S. Provisional Application No. 63/456,220, filed Mar. 31, 2023, the entire disclosure of which is incorporated by reference herein.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tags or labels attached to the physical objects. These tags or labels may be passive or active. The inter-networking capabilities may be leveraged for tracking locations of physical objects. In many situations, objects may be moved at different points in time, such as a package or equipment moved from a truck to a loading dock to a warehouse, or medical equipment that is moved between different rooms (or floors) in a hospital. These types of situations can be very challenging to determine the location of the object with suitable accuracy, including updating of the location as it changes. In addition, systems that use GPS or WiFi may suffer from signal dropout or transmitters going offline, which can reduce the ability to properly identify an object's location.

### BRIEF SUMMARY

Aspects of the disclosure provide a system comprising a tracking tag having circuitry configured to: operate the tracking tag in a normal operating mode for sending first beacon signals to enable the tracking of objects; and operate the tracking tag in a testing mode for sending second beacon signals to enable testing of the tracking tag.

In one example, the circuitry is configured to use a first encryption key for encrypting payloads when operating in the normal operation mode and to use a second encryption key to encrypt payloads of the second beacon signals when operating in the testing mode, the first encryption key being different from the second encryption key. In another example, the circuitry is further configured to use a first encryption key to generate an encrypted payload when operating the tracking tag in the testing mode, and the circuitry is further configured to use the first encryption key to generate a second encrypted payload when operating the tracking tag in the normal operation mode. In another example, the circuitry is configured to use a first encryption key for encrypting payloads of the first beacon signals when operating in the normal operation mode and not to encrypt payloads of the second beacon signals when operating in the testing mode. In another example, the system also includes a reader including an antenna configured to receive one or more of the first beacon signals; and one or more computing devices having one or more processors and being in communication with the reader, the one or more computing devices being configured to: induce the tracking tag to generate the second beacon signal in the testing mode, and determine whether to mark the tracking tag to be discarded. In this example, the system also includes a printer configured to mark the tracking tag to be discarded. In addition or alternatively, the one or more computing devices are configured to induce the tracking tag further by using an activation unit including a heat source which generates heat in order to cause a temperature sensor in the tracking tag to engage the testing mode. In addition or alternatively, the one or more computing devices are configured to induce the tracking tag further by using an activation unit including a near field communication coil which is configured to communicate with the tracking tag using near field communication in order to engage the testing mode. In addition or alternatively, the one or more computing devices are configured to induce the tracking tag further by using an activation unit including a radio frequency illuminator which is configured to send a signal to an energy harvesting antenna of the tracking tag in order to engage the testing mode. In addition or alternatively, the one or more computing devices are configured to induce the tracking tag further by using an activation unit including hardware to activate a contact switch of the tracking tag in order to engage the testing mode. In addition or alternatively, the one or more computing devices are configured to induce the tracking tag further by using an activation unit including hardware to bridge exposed contacts of the tracking tag in order to engage the testing mode. In addition or alternatively, the one or more computing devices are configured to induce the tracking tag further by using an activation unit including hardware that engages with a circuit that extends beyond a perimeter of the tracking tag in order to engage the testing mode, and wherein the computing devices are further configured to remove a portion of the circuit that extends beyond a perimeter after engaging the testing mode. In addition or alternatively, the circuitry is further configured to encrypt a payload of the first beacon signal using a first encryption key, and the one or more computing devices are further configured to: access a plurality of pre-stored encrypted payloads for the tracking tag; and compare the encrypted payload to the plurality of pre-stored encrypted payloads, and to determine whether to mark the tracking tag to be discarded further based on the comparison. In addition, the one or more processors are further configured to mark the tracking tag to be discarded based on whether the encrypted payload matches one of the plurality of pre-stored encrypted payloads. In addition or alternatively, the one or more computing devices are further configured to generate the plurality of pre-stored encrypted payloads prior to inducing the tracking tag. In addition or alternatively, the circuitry is configured to use a first encryption key for encrypting payloads when operating in the normal operation mode and to use a second encryption key to encrypt payloads of the second beacon signals when operating in the testing mode, the first encryption key being different from the second encryption key, and the one or more computing devices are further configured to: decrypt the encrypted payload using the second encryption key; and validate information of the decrypted payload, and to determine whether to mark the tracking tag to be discarded further based on the validation. In addition or alternatively, the circuitry is configured to use a first encryption key for encrypting payloads of the first beacon signals when operating in the normal operation mode and not to encrypt payloads of the second beacon signals when operating in the testing mode, and the one or more computing devices are further configured to validate information of the unencrypted payload, and to determine whether to mark the tracking tag to be discarded further based on the validation. In addition or alternatively, the system also includes a plurality of tracking tags arranged on a roll with the tracking tag. In this example, the system also includes a conveyor, a first spooling device on which the roll is arranged and a second spooling device on which a second roll is arranged, and one or more control units configured to rotate the first spooling device and the second spooling device at a desired rate of speed to move the tracking tag from the roll to the second roll and enable testing of the tracking tag. In addition, the reader is positioned to receive the first beacon signal when the tracking tag is between the roll and the second roll.

### BRIEF DESCRIPTION OF THE DRAWINGS

FIG. 1A illustrates various examples for localization of objects in accordance with aspects of the technology.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIGS. 4A-B illustrate example scenarios in accordance with aspects of the disclosure.

FIGS. 5A-B are example views of tracking tags in accordance with aspects of the disclosure.

FIGS. 6A-6B are example views of tracking tags in accordance with aspects of the disclosure.

FIG. 7 is an example end of line testing system for testing tracking tags in accordance with aspects of the disclosure.

FIG. 8 is an example flow diagram depicting an example method for end of line testing for a tracking tag in accordance with aspects of the disclosure.

FIG. 9 is an example flow diagram depicting an example method for end of line testing for a tracking tag in accordance with aspects of the disclosure.

FIG. 10 is an example flow diagram depicting an example method for end of line testing for a tracking tag in accordance with aspects of the disclosure.

### DETAILED DESCRIPTION

### Overview

The technology relates to end of line testing for tacking tags. Such tracking tags may provide accurate localization and tracking of articles or other objects transported, for example, by logistics providers. End of line testing may occur as part of the manufacturing process or immediately thereafter, but before the end user is ready to use the tracking tag. However, such testing presents various challenges. The goal of the testing may be to confirm that the tracking tag is able to send beacon signals at a desired signal strength, but if the tracking tag is activated too early, this may reduce the useful life of the tracking tag for the end user. In addition, because tracking tags are manufactured and provided on rolls of hundreds or even thousands of tracking tags, speed is of critical importance.

In order to enable the use of the aforementioned tracking tags on as many different types of articles to be shipped and other objects as possible, the tracking tags may be designed to be both thin and flexible. In this regard, the tracking tags may be configured as adhesive shipping labels which can generate beacon signals via BLUETOOTH or BLUETOOTH LOW Energy (BLE) protocols. As such, the tracking tags may typically beacon at low frequencies to preserve battery life. In such instances, the tracking tags may be manufactured on a roll of liner material which allows the tracking tags to be printed. When in use, each tracking tag may be peeled off of the roll of liner material and applied to an article to be shipped or another object by a human operator.

Production of these tracking tags may be achieved using a roll to roll process which presents unique testing challenges compared to approaches for testing RFID tags, credit cards, NFC cards. For instance, as noted above, the tracking tags may beacon at low frequencies to preserve battery life and before activation may be in a sleep or dormant mode to ensure expected shelf life and usable life for tracking objects. However, in order to perform testing of a large number of tracking tags quickly, each tracking tag must be activated to send a beacon signal for testing purposes. At the same time, the beacon signals sent by a tracking tag for testing may be synchronous and at a higher frequency than the rate at which the roll (or a portion of a roll) moves through the testing process. Moreover, the beacon signals include encrypted data which may require an encryption key to be able to read information of a payload of the beacon signals, but allowing the testing system access to the encryption key may compromise the security of the encryption key.

The features described herein may provide for a safe, secure, efficient and effective way to conduct end of line testing for tracking tags. Because the encryption key used to encrypt payloads when operating in a normal operating mode need not be shared with the testing system, this may reduce security risks of disclosure of the encryption key. As such, the encryption key may remain secure. In addition, the testing system provided herein may allow for a high line rate manufacturing process which adds very little or no latency as a result of the testing.

### Example Systems

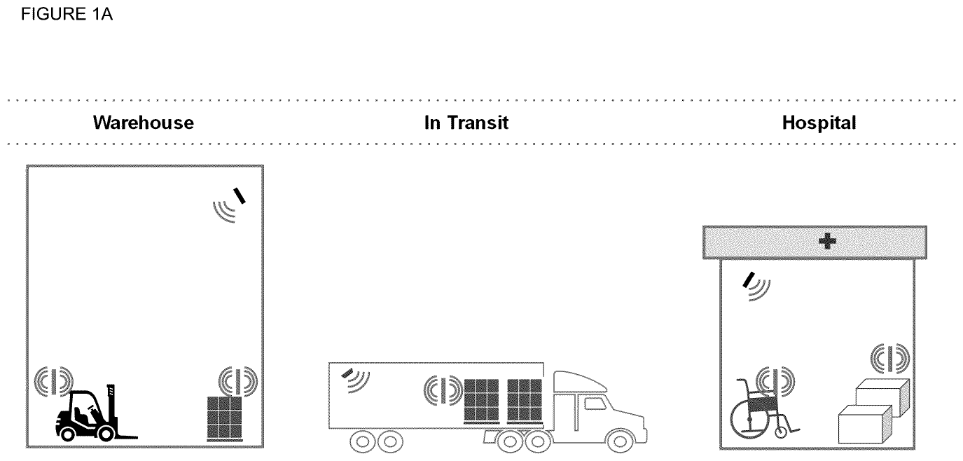

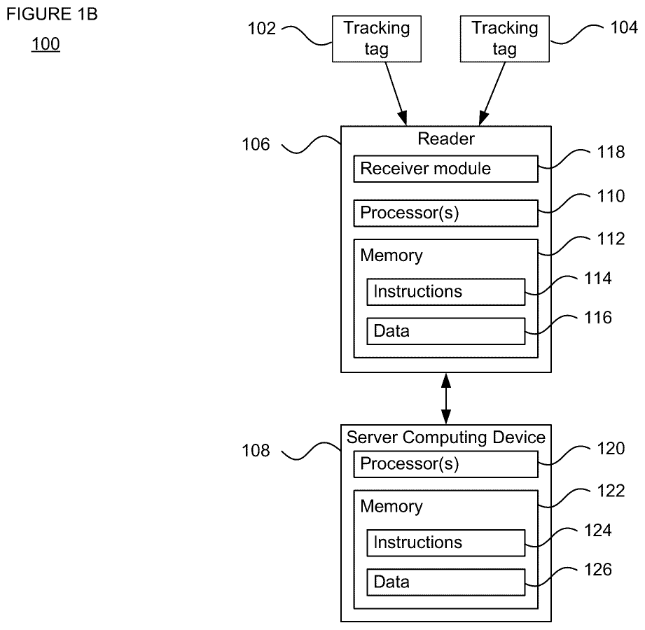

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations-in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where they are presumed to be based on an initial placement, is a valuable piece of information for an office manager, warehouse manager, nurse or orderly to have. Ideally, such people should be able to get the current location of a given object on their client computing device such as a laptop, mobile phone or smartwatch.

FIG. 1B is a functional diagram of a tracking system 100. The tracking system 100 may include a plurality of tracking devices, such as tracking tags 102 and 104, and a reader 106. As discussed further below, one or more server computing devices 108 may also be part of the tracking system 100. A given tracking tag may be placed on or otherwise attached to or inserted into an object to be tracked, such as a package, a piece of equipment, a vehicle, a warehouse section, a room, etc. While tracking tags 102 may be associated with objects such as packages, equipment or vehicles (e.g., a forklift or an autonomous fulfillment robot that can retrieve packages from different locations in a warehouse), tracking tags 104 may be fixed to an aisle in a warehouse or from a specific room in a hospital. Thus, different tracking tags may be used depending upon customer needs. As an example, different customers may have varying accuracy and “liveliness” needs. For instance, one customer may only want to know aisle-level accuracy every day (e.g., before a warehouse closes for the evening), while another customer such as a hospital nurse may need to know which room a piece of equipment is in every hour so that it can be accessed should a patient need such equipment. Each tracking tag 102 or 104 may emit an informational signal, for example a beacon signal, via an antenna, such as using the transmitting device, to communicate data. In this regard, each tracking tag may include an identifier chip (such as for radiofrequency (RF) identification) and/or a transmitting device (such as an RF module configured to transmit beacon signals using a selected frequency band and transmission protocol). In this regard, the beacon signals may simply transmit identifying information in order to enable tracking of objects in the case of tracking tags discussed further below. To facilitate this, each tracking tag may be embedded with a unique identifier, such as a unique MAC address or BLUETOOTH identifier, which may function as a tracking tag identifier. This tracking tag identifier may be assigned to the tracking tag during the manufacturing or provisioning processes (described further below).

The transmitting device may send such information via radio frequency transmission in a selected frequency band, using a standard or proprietary protocol. By way of example, the transmitting device may employ a BLUETOOTH (e.g., a BLUETOOTH Low Energy (BLE)) or 802.11 protocol in the 2.4 GHZ and/or 5 GHz frequency bands. In some examples, each beacon tracking tag and each tracking tag uses the BLUETOOTH or BLE protocol.

In some instances, the tracking tags may include one or more sensors. In such instances, the aforementioned communicated data may be formatted according to the selected protocol and include one or more sensed characteristics of the given tracking tag or its environment. For example, the sensed characteristic may be a temperature, a location, motion, battery conditions, trip conditions, and/or other detectable characteristics of the tracking devices or its environment.

The reader 106 may be a computing device configured to detect the beacon signals emitted by the plurality of tracking tags 102 and 104, then store and/or transmit data related to the tracking tags. While only one reader is shown in FIG. 1B, the system may employ multiple readers. The reader 106 may include one or more processors 110, memory 112 and other components typically present in general purpose computing devices. The reader 106 includes a receive module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion.

The one or more processors 110 may be any conventional processors, such as commercially available CPUs or microcontrollers. Alternatively, the one or more processors may be a dedicated device such as an ASIC or other hardware-based processor, such as a field programmable gate array (FPGA). Although FIG. 1B functionally illustrates the one or more processors, memory, and other elements of the reader 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader 106. Accordingly, references to a processor or computing device will be understood to include references to a collection of processors or computing devices or memories that may or may not operate in parallel.

The memory 112 stores information accessible by the one or more processors 110, including instructions 114 and data 116 that may be executed or otherwise used by the one or more processors 110. The data may include sensed characteristics from any of the tracking tags 102 and/or 104 received by the reader 106. The memory 112 may be of any type capable of storing information accessible by the one or more processors, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by the one or more processors 110 in accordance with the instructions 114. For instance, although the claimed subject matter is not limited by any particular data structure, the data may be stored in computing device registers, in a relational database as a table having a plurality of different fields and records. 8ML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

In some implementations, the tracking system 100 may further include a central server, such as one or more server computing devices 108 accessible by the one or more processors 110 of the reader 106. In some implementations, one or more tracking devices in the tracking system 100, such as a tracking tag 104, may be configured to obtain and communicate data directly to the one or more server computing devices 108. The one or more server computing devices 108 may include one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the one or more processors 120. Data 126 and instructions 124 may be the same or similar type as the data 116 and instructions 114, respectively.

After detecting the beacon signals of one or more tracking tags 102 or 104, the reader 106 may transmit the data from the tracking tags to the one or more server computing devices 108 through an existing connection or through a network. Thus, in this case the reader 106 may include a transmitter module (not shown) that is configured for wired or wireless transmission to the server computing device. The data may be received in a series of payloads (e.g., data packets) either continually, at one or more set intervals, or ad hoc whenever the tracking tags transmit. Thus, when there are multiple tracking tags, the data is effectively received as a plurality of separate data streams. A given payload (which may comprise one or more data packets) may include measurements taken at one or more time intervals, each of which may have a corresponding timestamp. In one scenario, the reader 106 may include a transceiver including both a receiver and a transmitter, which is configured to receive beacon signals from the tracking tags 102 and 104 and also to send and receive information with the server computing devices 108.

The one or more server computing devices 108 may be configured to track characteristics of the tracking devices for one or more alerts based on a plurality of conditions. The plurality of conditions may include at least one condition for each characteristic, such as a minimum, a maximum, a threshold, a duration, or a geofence. The conditions may be predetermined or set based on user input. For example, a first alert may be set for when (1) a temperature is greater than, e.g., 0° C.) to 11° C., for 30 minutes and (2) the tracking device is on a trip, which may indicate overheating of a cooled package or storage compartment. A second alert may be set for when (1) no motion is detected for 11 minutes, (2) 2 of 3 locations are in a geofence, and (3) the tracking device is on a trip, which may indicate that a package is out for delivery. A third alert may be set for when (1) a threshold amount of light is detected from inside a package and (2) the tracking device is on a trip, which may indicate unexpected opening of the package or tampering. A fourth alert may be set for when (1) a threshold amount of light is detected from inside a package and (2) 2 of 3 locations are in a destination geofence, which may indicate opening of the package after delivery or receipt. Many other alert conditions and tracking scenarios are possible, and the above examples are not intended to be limiting.

The tracking system 100 may optionally include an application that may be installed on one or more client computing devices. Using the application, the client computing devices may access the data from the reader 106 and/or the server computing devices 108 through a network.

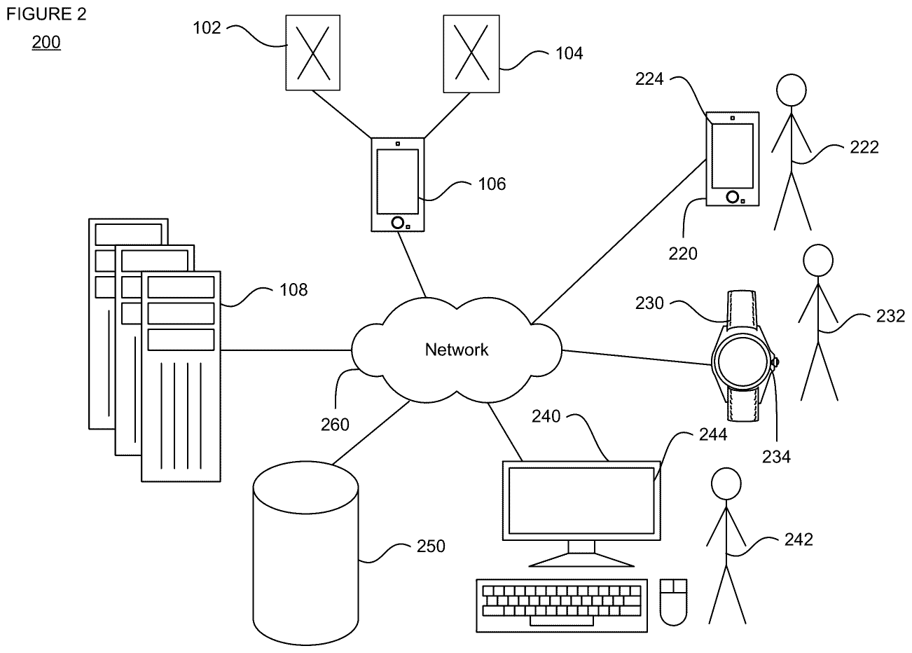

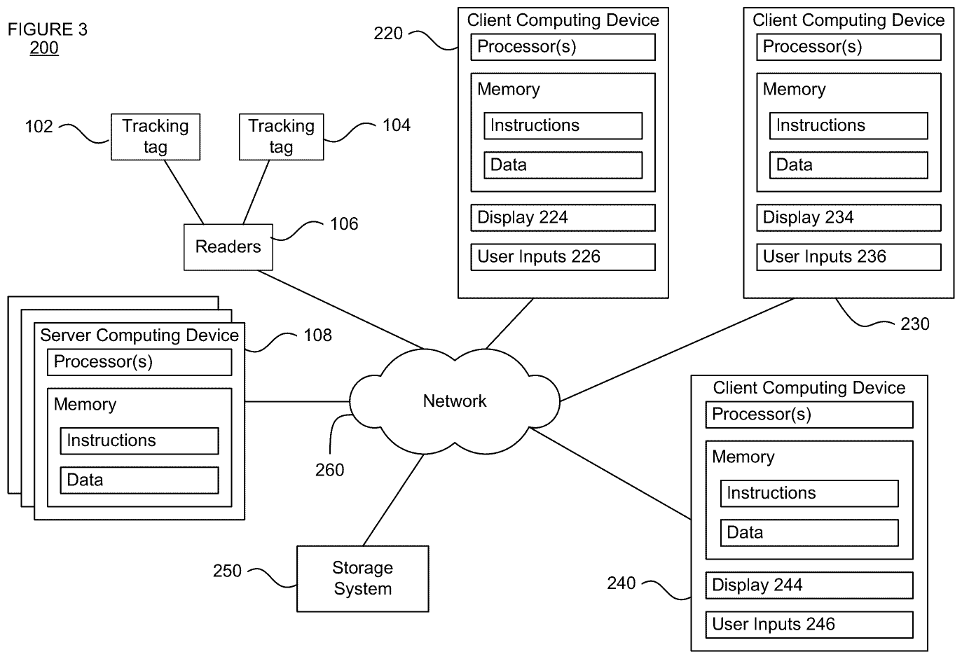

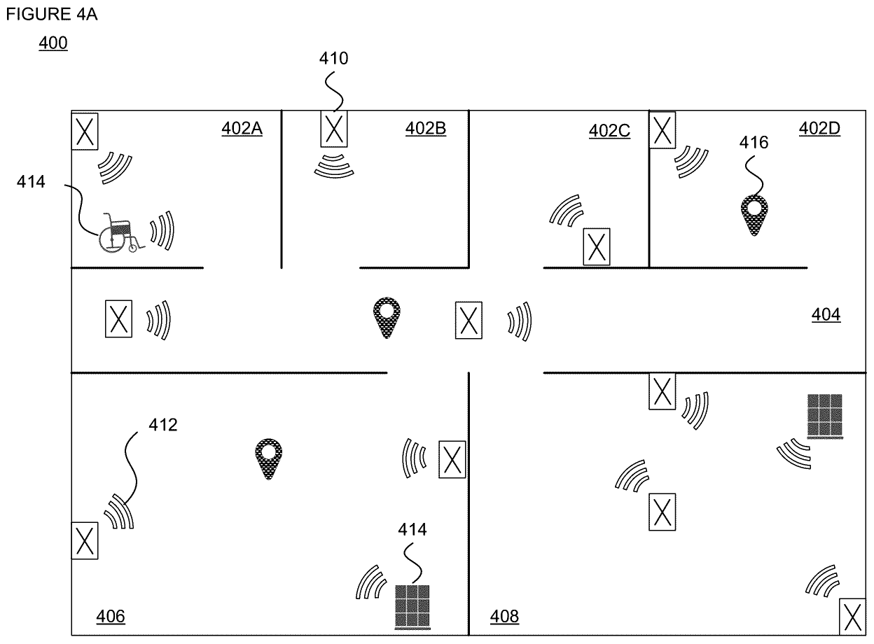

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking tags 102, 104, reader 106, and server computing device 108. Although only a few tags and computing devices are depicted for simplicity, a typical system may include significantly more.

The network 260, and intervening nodes, may include various configurations and protocols including short range communication protocols such as BLUETOOTH, BLUETOOTH LE, the Internet, World Wide Web, intranets, virtual private networks, wide area networks, local networks, private networks using communication protocols proprietary to one or more companies. Ethernet. WiFi and HTTP, and various combinations of the foregoing. Such communication may be facilitated by any device capable of transmitting data to and from other computing devices, such as modems and wireless interfaces.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including one or more processors (e.g., a central processing unit (CPU)), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display, or a netbook that is capable of obtaining information via the Internet or other networks. As an example, the user may input information using a small keyboard, a keypad, microphone, using visual signals (gestures) with a camera or other sensor, or a touch screen.

As with memory 112, storage system 250 can be of any type of computerized storage capable of storing information accessible by the one or more server computing devices 108, such as a hard-drive, memory card. ROM. RAM. DVD. CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250) may store information about the tracking tags including, for example, location, status (e.g., activated and when), identifiers, last update, sensor data (e.g., temperature measurements), information about the object to which the tracking tag is attached (e.g., manufacturing data), and so on. In this regard, the information may be determined from received beacon signals provided to and updated at the storage system 250 by any of the one or more server computing devices 108 and/or client computing devices 220, 230, 240.

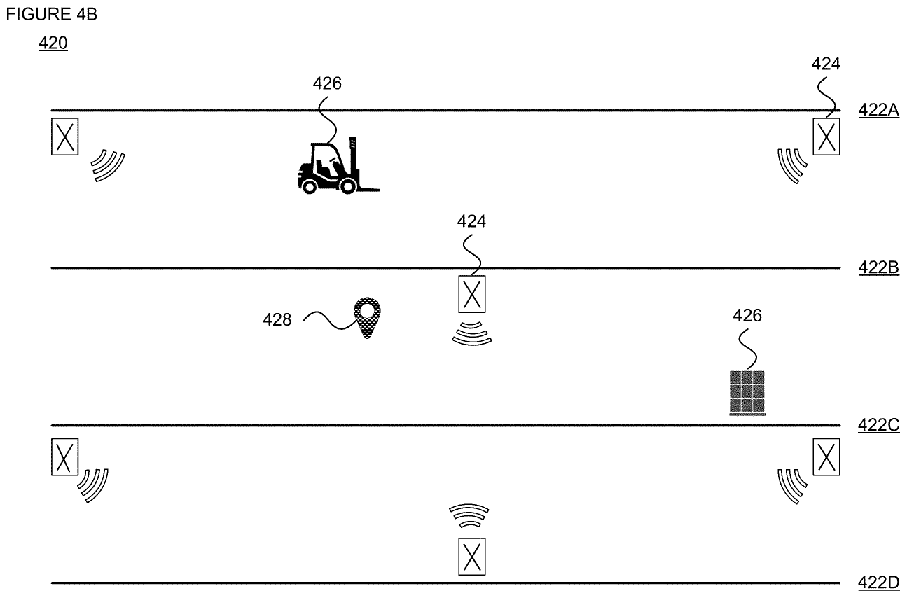

FIG. 4A illustrates one example 400 of a system having a number of tracking tags arranged in various locations of a building (e.g., a hospital). In this example, there may be a number of rooms 402A-402D, such as patient rooms, along one side of a hallway 404. On the opposite side of the hallway 404 there is a storage room 406, such as to house equipment or supplies, as well as another room 408, which may be a meeting room, common area, rehab facility or the like. One or more fixed tracking tags 410 corresponding to the tracking tags 102 or 104 may be located in each room, including the hallway. Each fixed tracking tag 410 is configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking tag 410 that is located on the ceiling, pillar or floor. In some implementations, the tracking tag 410 may be configured to emit beacon signals with information associated with its environment (e.g., temperature, humidity, etc.).

Tracking tags 414 may correspond to tracking tags 102 or 104 when placed on a variety of objects (e.g., a case of supplies as shown in storage room 406 or a wheelchair shown in room 402A). In some instances, the tracking tags may also be configured to emit beacon signals with information associated with the object on which the tracking tag is applied (e.g., temperature, motion information, object details, and/or other detectable characteristics of the tracking device or its environment). Readers 416 may be found at various locations in the building, such as in a patient room, the storage room, the hallway or other location. Note that even if transmitted omnidirectionally, the beacon signals from a given tracking tag may be attenuated in a non-uniform manner due to the presence of walls, furniture, floors/ceilings, equipment, etc.

FIG. 4B illustrates another example 420 of a system having a number of fixed tracking tags positioned along different aisles in a warehouse setting. In this example, there are a number of aisles 422A-422D, although there may be more (or fewer) aisles, and the aisles may be arranged in other configurations than what is shown. Here, fixed tracking tags 424 are located at different places for the aisles, such as along aisle end caps, along the ceiling (or floor), on shelves, storage lockers, cabinets or other places along the aisle, etc. Similar to FIG. 4A, fixed tracking tags 426 are placed on or otherwise associated with different objects, such as a pallet of equipment or a forklift that retrieves items from their locations in the warehouse. As above, the fixed tracking tags are configured to transmit beacon signals that are detectable by one or more readers 428.

In order to determine the location of a given tracking tag, the system may use signal strength information obtained from the beacon signals of one or more tracking tags. A series of beacon signals may be ramped at different power levels (a ramped sequence). Evaluating the received beacon signals in view of their transmitted power can enable the system to determine which room or other location at which a given tracking tag is located. From that, the system is able to determine a location for a given tracking tag (and thus its corresponding object) with a suitable degree of certainty, such as by triangulating its position relative to the relevant tracking tags.

In order to enable the use of the aforementioned tracking tags on as many different types of objects and locations as possible, the tracking tags may be designed to be both thin and flexible. In addition, each tracking tag may be passive, such as a tracking tag configured to activate or be powered by environmental energy, or active, configured to include a battery or be coupled to another power source. In the case of a battery, delaying activation of the battery until the end user is ready to use the tracking tag is critical to extending the useful life of the tracking tag.

In order to enable the use of the aforementioned tracking tags on as many different types of articles to be shipped and other objects as possible, the tracking tags may be designed to be both thin and flexible. In this regard, the tracking tags may be configured as adhesive shipping labels (e.g., 4×6 shipping labels commonly used by logistics companies to ship packages such as envelopes, boxes, bags, etc.).

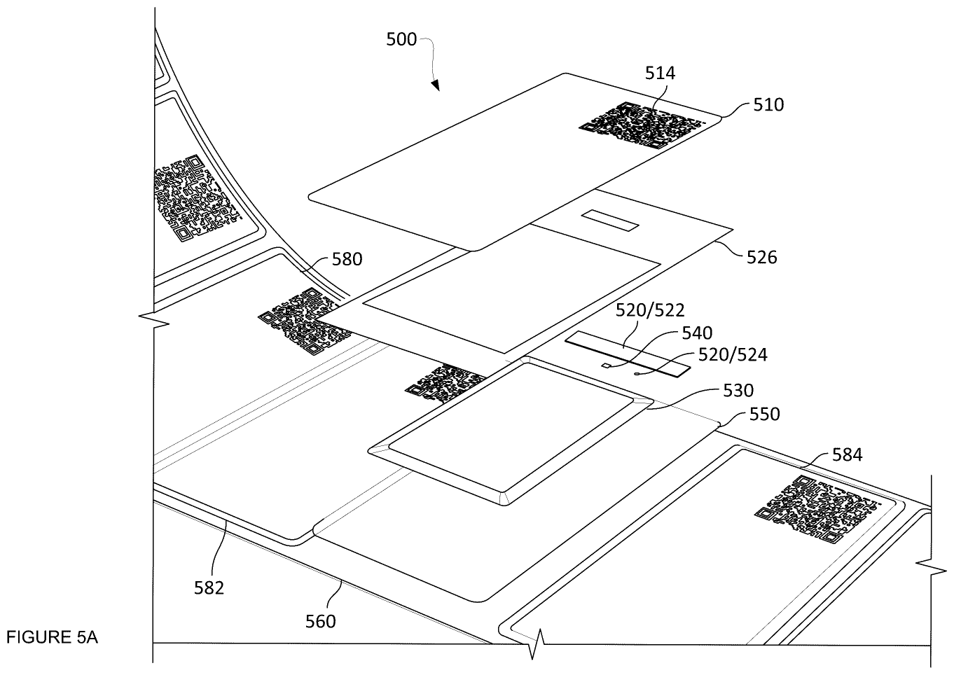

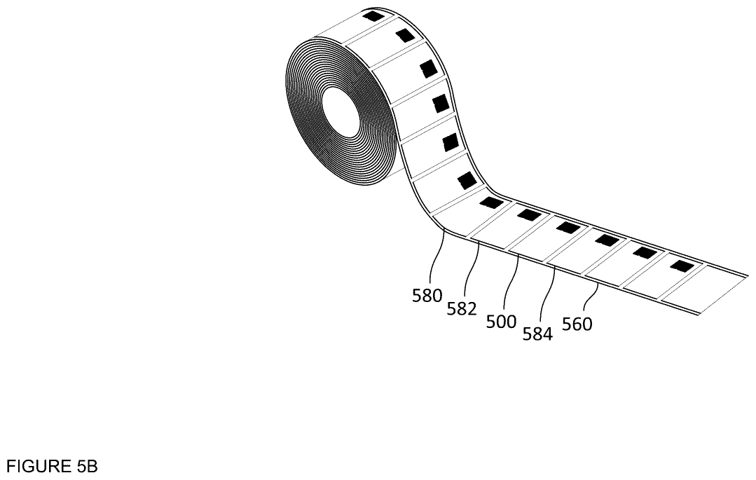

Each tracking tag may include various components such as a top layer for printing a label, a frame, beacon transmission circuitry, a bottom layer including an adhesive (for attaching the tracking tag to an article to be shipped or another object). FIG. 5A is an example top-down, view of a plurality of tracking tags 500, 580, 582, 584 which may be configured the same as or similarly to any of the tracking tags 102, 104, 410, 414 described above. In this example, the tracking tag 500 is depicted in an exploded view and includes a top layer 510, beacon transmission circuitry 520, one or more batteries 530, a processor 540, and a bottom layer 550 below the top layer and beacon transmission circuitry. Tracking tags 580, 582, 584 may be configured the same or similarly to tracking tag 500.

The tracking tag 500, as with the tracking tags described above, may also include beacon transmission circuitry 520. In this example, the beacon transmission circuitry includes an antenna 522 and capacitor 524 which may be arranged on a flex inlay 526.

The top and bottom layers may provide impact protection, prevent the ingress of liquids and other contaminants, as well as provide a smooth surface for applying labels or on which to print information (whether or not an additional adhesive label is not used). The top layer 510 and bottom layer 550 may be a thin sheet (e.g., 0.1 mm) of polyester or paper each with an adhesive backing. In this regard, the top layer 510 may be pressed onto the bottom layer 550 with the beacon transmission circuitry 520, one or more batteries 530, and the processor 540) (and in some instances, a frame or flex inlay 526 as discussed further below) therebetween. In this regard, the beacon transmission circuitry 520, one or more batteries 530, and processor 540) are arranged between the top layer and the bottom layer. In addition, the adhesive backing on the top layer may secure the top layer to the bottom layer, and the adhesive backing on the bottom layer may be used to attach the tracking tag to an object (e.g., a package). Alternatively, the bottom layer may include adhesive on opposing sides (e.g., a top side and a bottom side) of the bottom layer allowing for the attachment of the top layer onto the bottom layer without the additional adhesive. As noted above, the adhesive backing may include commercially available glues or double-sided tapes such as those provided by 3M including 3M Double Coated Tape 93015LE.

The top layer 510 may be configured to be printed on during manufacturing and/or by the end user before application of the tracking tag on an object (e.g., a package, a wall, a shelf, etc.). For example, the end user may be able to print tracking and identifier information directly onto the top layer. As such, top layer 510 may be a top adhesive label with a pre-printed visual code 514. For instance, the tracking tag 500 may have a visual code such as QR codes or barcodes printed on the tracking tag or may include a passive RFID or a no power NFC chip, etc, which can be read by the input devices (e.g., a scanner). Alternatively, the tracking and identifier information may be printed onto a separate label and applied to a surface (e.g., the top layer) of the tracking tag 500 when ready to use the tracking tag. Such labels may include proprietary labels or commercially available labels such as those provided by AVERY including the Avery Ultra Duty White Film 94211.

The beacon transmission circuitry 520 may be situated at least partially within the flex inlay 526 or a printed circuit board (PCB) (not shown) and may be connected to the one or more batteries 530 via traces. The PCB may include various features such as an identifier chip and/or a transmission device for the purposes of transmitting beacon signals. The PCB may be a commercially available PCB which can be connected to one or more batteries. For example, the PCB may include PCBs such as surface mount technology (SMT) PCBs including devices that enable BLUETOOTH LE 4.0 technology for the purposes of enabling the aforementioned beacon signals.

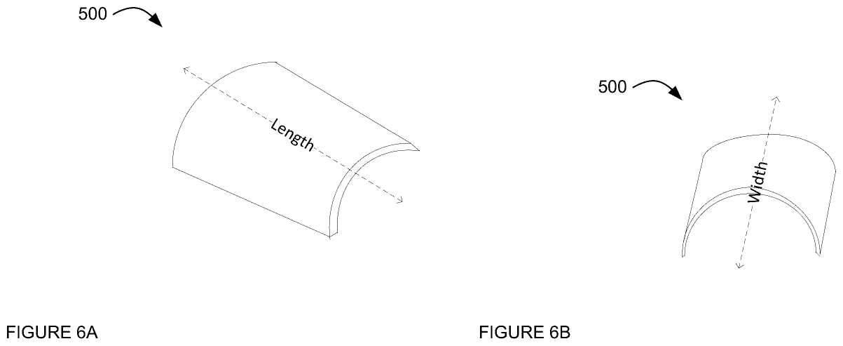

The one or more batteries 530 may be relatively thin. For example, the one or more batteries 530 may include a coin cell, prismatic, pouch, thin-film, or screen-printed battery. For example, as depicted in FIG. 5A, the one or more batteries 530 is a thin film battery. In this example, the thin film battery may be a commercially available thin-film MOLEX 13299-0002 battery. CPO042350 battery provided by RENATA BATTERIES, etc. In this regard, given the configuration of the tracking tag 500, this may allow for bending along the length of the tracking tag 500 as depicted in FIG. 6A as well as along the width of the tracking tag 500 as depicted in FIG. 6B.

Alternatively, coin cell batteries, such as CR2016, CR1216, CR1220. CR2012, etc, may be used. Coin cell batteries are typically used in powered badges and key cards and provided various benefits such as improved safety (e.g., because of a metal encased battery with reduced puncture danger as compared to thin-film batteries), higher capacity or rather longer life for extended runtime operations, lower costs, easier storage (for example, coin cell batteries usually slot into a battery holder and thus can be stored separately and installed closer to time of use which may also allow tracking tags to be stored in facilities not rated for battery storage whereas flatpack or other custom batteries are typically bonded to the device at manufacturing), lower lead times (e.g., for manufacture and availability), and so on.

In addition, although coin cell batteries do not bend, their smaller form factor may allow for lower stiffness in the tracking tag. In other words, the tracking tag may be more tolerant to bending at points away from the coin cell battery whereas for a thin-film battery, bending should be avoided in order to prevent damage to the thin-film battery which may have a larger form factor. The further the rigid portions are located away from one another and the PCB, the greater the amount of flexibility that can be achieved. In this regard, given the configuration of the tracking tag 500, bending along the length of the tracking tag 500 as depicted in FIG. 6A may be less desirable (e.g., likely to cause damage to the rigid components) than bending along the width of the tracking tag 500 as depicted in FIG. 6B.

The processor 540 may be configured the same or similarly to processors 110 and may include conventional processors, such as commercially available CPUs. MCUs. ASICs etc, or customized versions of these. For instance, the processor 540 may also include BLUETOOTH radio capabilities such as the NORDIC SEMICONDUCTOR nRF52832 or INPLAY IN100. In some instances, the processor 540 may actually comprise multiple processors that may or may not be stored within the same physical housing.

In some instances, as an alternative to the flex inlay, the tracking tag may include a frame (not shown) to provide additional support to the tracking tag. For example, the frame may be formed from various materials such as polycarbonates or other plastics such as cellulose fiber (paper/wood), polyethylene (PE/LDPE/HDPE), polypropylene (PP), Vinyl (PVC), Nylon, Polyurethane (foam), rubber, silicone, resin, carbon fiber. The frame may be die-cut, molded or manufactured using other processes. The materials of the frame may be selected in order to enable the frame to be strong and puncture resistant while also flexible. In this regard, the frame may enable the tracking tag 500 to be attachable to objects (via the adhesive of the bottom layer 550) of various shapes including curved surfaces, such as depicted in FIGS. 6A and 6B.

In some instances, a liner sheet or liner material, such as liner material 560 of FIGS. 5A, 5B, may be used to protect the adhesive before the tracking tag is attached to an object. The liner material 560 may allow adhering multiple labels to the liner material during manufacturing and may be either rolled or folded into one continuous strip of labels to feed into a printer. For instance, before using the tracking tag 500 may be attached to the liner material 560 such as craft or other paper to protect the adhesive on the bottom layer of the bottom surface before use. In such instances, the tracking tags may be provided on a roll which can be run through a printer to enable printing of information on the top layer of the tracking tags. In this regard, the tracking tags 500, 580, 582, 584 of FIG. 5A may represent a small portion of a larger roll which has been unrolled. Thus, a plurality of the tracking tags may be manufactured on a roll of the liner material 560, such as a waxed paper liner or other appropriate backing, which allows the tracking tags to be printed.

When in use, each tracking tag may be peeled off of the roll of liner material and applied to an article to be shipped or another object by a human operator. In this regard, before applying the tracking tag 500 to an object, the tracking tag may be removed from the liner material (e.g., peeled away) in order to expose the adhesive on the bottom surface of the bottom layer. As noted above, the tracking tag may be printed on during manufacturing and/or by a human operator before removal from the liner material application of the tracking tag on a package to be shipped or another object. Thereafter the tracking tag 500 may be activated (in order to initiate the beacon signals) in a normal operating mode for tracking objects as described above and attached to an object for tracking purposes.

In addition to the normal operating mode, as discussed further below, each tracking tag may have a sleep or dormant mode as well as a testing mode as discussed further below. For instance, when in the sleep or dormant mode, the tracking tag may be disabled “sleep mode” by defaulting to a chip-enabling pin being disabled. When the tracking tags are ready to be used, a circuit loop may be broken which enables the chip-enabling pin and activates the tracking tag in the normal operation mode so the tracking tag sends beacon signals. For testing, the chip-enabling pin may be temporarily enabled in order to cause the tracking tag to enter the test mode and send beacon signals.

Although not depicted in FIGS. 5A and 5B, the tracking tag may include additional hardware distinct from or incorporated into the beacon transmission circuitry 520 and/or the processor 540) in order to enable the tracking tag to enter into a testing mode as detailed further below:

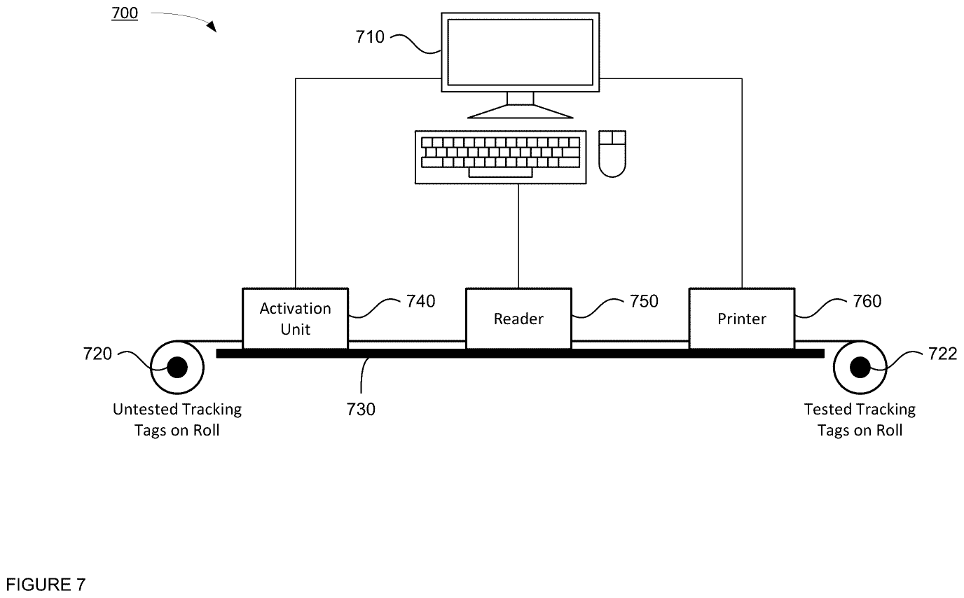

FIG. 7 is an example end of line testing system 700 for testing tracking tags, such as tracking tag 500 after manufacture and before use by an end user. In this example, the system 700 includes one or more computing devices 710. The one or more computing devices may have one or more processors, memory and instructions.

The computing devices 710 may be in communication with various other devices in the testing system such as spooling device 720, 722, conveyor 730, activation unit 740, reader 750, and printer 760 over one or more networks. Such communication may be achieved via wired or wireless connections as described above with network 260.

For example, spooling devices 720, 722 may be arranged at opposite or opposing ends of a conveyor 730. Spooling devices 720, 722 may include a roller, dowel or other feature upon which a roll of tracking tags may be placed. The computing devices 710 may send signals to one or more control units for the spooling devices and/or conveyor (which may be stationary or may include a moving belt) in order to cause the liner material and tracking tags to move at a desired rate of speed from spooling device 720 to spooling device 722. A roll of untested tracking tags, such as the tracking tag 500, may be inserted onto a spooling device 720) and move along the conveyor 730 to the spooling device 722. Once a tracking tag has reached the spooling device 722, the tracking tag may have already been tested by the testing system.

Along the conveyor may be arranged an activation unit 740, reader 750, and printer 760, each in communication with the computing devices 710. The activation unit 740 may include various hardware for activating the tracking tag in a testing mode as described further below: The reader 750 may be configured the same or similarly to the reader 106 described above. The printer 760 may be a conventional laser or inkjet printer or other device configured to mark tracking tags as described further below:

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

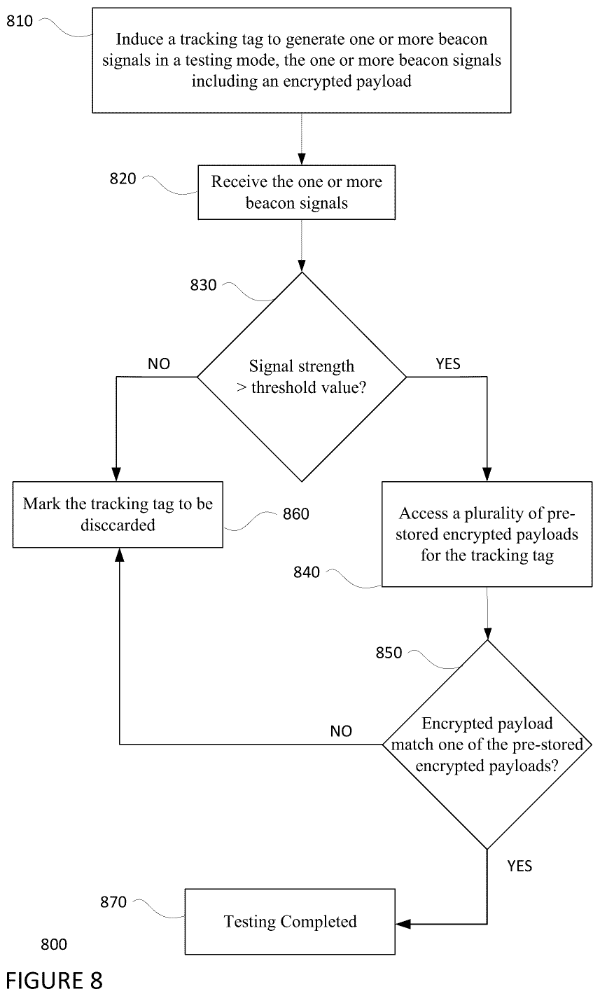

FIG. 8 is an example flow diagram 800 depicting an example method for end of line testing for a tracking tag, such as a tracking tag 500, arranged on a liner material, such as liner material 560 and moving through the testing system 700 as described above. At block 810, a tracking tag is induced to generate one or more beacon signals in a testing mode. As noted above, this testing mode may be different from a normal operation mode for the tracking tag. The one or more beacon signals include an encrypted payload. As noted above, the activation unit 740 may induce the tracking tag 500 into generating the one or more beacon signals in a testing mode. In response, the tracking tag 500 may generate the one or more beacon signals including information such as an encrypted payload.

During the manufacturing process, before the top layer 510 (and or bottom layer 550) are applied to the flex inlay, information may be encoded into the beacon transmission circuitry 520. For example, a first encryption key may be encoded along with an identifier (e.g., an identifying code or numerical value for the tracking tag). In some instances, the first encryption key may be a “private” encryption key for encrypting data and decrypting encrypted data. Each tracking tag may be encoded with a different first encryption key in order to encrypt a payload of a beacon signal and thereby increase the security of such beacon signals transmitted by different tracking tags. For instance, when preparing the beacon signals described above, the processor 540 may use the first encryption key to encrypt a payload for a beacon signal. In this regard, the first encryption keys may be highly sensitive data and therefore need to be kept secure.

When the tracking tag is activated and sending beacon signals in the normal operating mode, the processor 540 may use the first encryption key to encrypt a payload for the tracking tag. A payload may include information, such as for example, the aforementioned tracking tag identifier, general purpose states indicating whether the tracking tag is activated or in some cases activated but in a testing mode, as well as other information about the tracking tag including sensor data, such as battery voltage and temperature if the tracking tag includes a temperature sensor. The processor 540 may then use the beacon transmission circuitry to send the beacon signal with the encrypted payload.

The testing mode may be used to generate a finite and predetermined number of beacon signals for testing purposes as discussed further below. In some instances, a tracking tag may be caused to enter the testing mode for a predetermined period of time in order to send such beacon signals. Once the predetermined number of beacon signals have been generated and/or predetermined period of time has passed, the tracking tag may revert from the testing mode back to the sleep or dormant mode. For instance, the chip-enabling pin may no longer be temporarily enabled.

In some instances, when operating in the testing mode, the beacon transmission circuitry 520 may transmit beacon signals at a higher rate than when the tracking tag is in a normal operation mode for tracking in order to ensure that the beacon signals are captured by the testing system. In other words, the beacon signals sent by the tracking tags when in the testing mode must be at a higher frequency than the rate at which the roll (or a portion of a roll) moves through the testing system. When operating in the normal operation mode, the tracking tags may typically transmit beacon signals at lower frequencies, for instance every 1.285 to 6 seconds to preserve battery life.

In addition, if a tracking tag is moving through the testing system 700 and passing the reader 750 at a higher rate of speed, the tracking tag must be sending beacon signals during the period of time for which the tracking tag is in range of the antenna of the reader. Otherwise, the reader may not receive any of the beacon signals. Moreover, if the proximity between the tracking tag and the antenna of the reader is not consistent with each tracking tag being tested, the testing system will see varying signal strengths. This variation may make it more difficult to determine if a tracking tag is sending beaconing signals of sufficient signal strength (e.g., at the correct power). At the same time, if many tracking tags are sending beacon signals at once, the testing system may see packet collisions or beacon signals from different devices that overlap in time. To address these concerns, the tracking tags may only send beacon signals synchronously when operating in the testing mode. A plurality of different approaches may be used to cause a tracking tag, such as tracking tag 500, to enter into the test mode and to generate the aforementioned beacon signals at the desired testing rate. Referring to FIG. 7, the activation unit 740 may include various features described below in order to activate the tracking tag in the testing mode.

In one example, the tracking tag 500 may include a temperature sensor in communication with the processor 540. When the tracking tag is passed through an area of the testing system 700 with higher or lower temperature than the ambient temperature, if a threshold temperature (e.g., X degrees above ambient temperature or Y degrees below ambient temperature) is met, the temperature sensor may send a signal or an interrupt to the processor 540 causing the processor to engage the testing mode and transmit a plurality of beacon signals at the desired testing rate. The higher or lower temperature may be achieved by passing the tracking tag by a heat source (e.g., an electric heater or a puff of hot air) or a source of cool air (e.g., an air conditioner or puff of cool air) of the activation unit 740. Of course, as it may take some time for the temperature sensor to register a temperature change, it may take a fraction of a second or so for the activation to occur. In that regard, the activation unit 740 and the reader 750) must be appropriately spaced depending on the speed of the conveyor 730 as controlled by the computing devices 710.

In another example, the processor 540 of the tracking tag may include a near field communication (NFC) chip or the processor 540 may have integrated NFC capabilities. In such instances, the tracking tag may be passed by an NFC coil of the activation unit 740. The NFC coil may be used to communicate with the NFC chip or processor 540 with integrated NFC capabilities directly using near field communication in order to override a pulldown on the chip-enabling pin. This may cause the processor 540 to engage the testing mode and transmit a plurality of beacon signals at the desired testing rate. In such instances, the tracking tag may also include an NFC antenna in order to receive the NFC signals.

In another example, the beacon transmission circuitry 520 may include an energy harvesting antenna. For instance, a 900 MHZ energy harvesting antenna may be used. In this example, the activation unit 740 may include a radio frequency (RF) illuminator that can send a signal to the tracking tag via the energy harvesting antenna. The signal may be sufficient to override a pulldown on the chip-enabling pin in order to cause the processor 540 to engage the testing mode and transmit a plurality of beacon signals at the desired testing rate.

In another example, the tracking tag may include a contact switch (e.g., a button or dome switch). In this example, the activation unit may include a device such as a roller which can depress the contact switch. This may engage the chip-enabling pin which causes the processor 540 to engage the testing mode and transmit a plurality of beacon signals at the desired testing rate.

In another example, the tracking tag may include exposed contacts (e.g., copper contacts). In this example, the activation unit 740 may include a device such as a roller with a metal outer liner (e.g., copper) which bridges the contacts on the tracking tag in order to form an electrical connection between the contacts. This engages the chip-enabling pin which may cause the processor 540 to engage the testing mode and transmit a plurality of beacon signals at the desired testing rate.

In another example, the tracking tag may include a circuit which extends beyond an outer perimeter of the tracking tag. In this example, the activation unit 740 may include a device such as a roller with a metal outer liner (e.g., copper) which engages the chip-enabling pin. This may cause the processor 540 to engage the testing mode and transmit a plurality of beacon signals at the desired testing rate. In some instances, the activation unit or another device of the testing system (also in communication with the computing devices 710) may include a cutting device (e.g., a die cutting machine) which removes the circuit beyond the perimeter of the tracking tag after the testing mode has been activated.

At block 820, the one or more beacon signals including the encrypted payload are received. The beacon signals may be captured via the antenna of the reader 750.

At block 830, a signal strength of the received one or more beacon signals is compared to a threshold value. If the signal strength meets the threshold value (e.g., is greater than or equal to), the signal strength may be considered good enough for use by the end user. If the signal strength does not meet (e.g., is less than) the threshold value, the tracking tag may not be functioning properly (e.g., there may be some problem with the tracking tag) and may be marked to be discarded as shown in block 860. This marking may occur, for example, via the printer 760.

At block 840, a plurality of precomputed encrypted payloads is accessed. These precomputed encrypted payloads may be generated prior to the testing based on potential expected operational ranges for each individual tracking tag. In this regard, when the first encryption key is encoded into the tracking tag 500, this encryption key need not be sent to the testing system (if remote from the system that encodes information into the tracking tags). At the same time, a manufacturing computing device (which may be configured the same or similarly to any of the computing devices described above) that encodes the first encryption key or another secure computing device (such as the one or more server computing devices 108) may compute a plurality of encrypted payloads for the tracking tag 500 using the first encryption key. Again, because the first encryption keys for each tracking tag may be different, the manufacturing computing device or the another security computing device may generate a plurality of encrypted pay loads for each particular tracking tag to be tested. Thus, each tracking tag may be associated with a different plurality of encrypted payloads. These different pluralities of encrypted payloads may be sent to the computing devices 710 and stored in memory, for example indexed by a corresponding tracking tag identifier. In this regard, the pluralities of encrypted payloads may be accessible by the computing devices 710.

As an example, if the tracking tag includes a sensor which measures temperatures to 0.1 degrees Celsius, the manufacturing computing device or another secure computing device may generate precomputed encrypted payloads for a plurality of temperature values in various increments such as every 0.1 degree or more or less. In this regard, when a tracking tag is operating in the testing mode, the resolution of a temperature sensor may be reduced. For instance, if a temperature sensor is able to generate measurements to several decimal places (e.g., to 0.01 or 0.001 degree), when in the testing mode, the processor may round measurements from the temperature sensor to a particular place, such as to whole numbers or 0.1 degree. This may decrease the number of precomputed encrypted payloads by a factor of 10 or even 100 while having minimal impact on the usefulness of the testing. Similar reductions of resolution may be applied to other types of sensor data or analog values when the tracking tag is operating in the testing mode in order to decrease the number of precomputed encrypted payloads needed.

At block 850, the encrypted information is compared to the plurality of precomputed encrypted payloads for the tracking tag. If the encrypted information is the same as or within some expected deviation of at least one of the plurality of precomputed encrypted payloads and the signal strength meets the threshold value, the tracking tag may be considered to be functioning properly and the testing is completed as shown in block 870. If the encrypted information is not within some expected deviation of at least one of the plurality of precomputed encrypted payloads, the tracking tag is marked to be discarded as shown in block 860. This marking may occur, for example, via the printer 760. The comparison may be performed using pattern matching approaches. Because no encryption keys are shared with the testing system 700 and the encrypted information does not need to be decrypted, this may reduce security risks of disclosure of the first encryption keys of the tracking tags. As such, the first encryption keys are not needed for the testing and may remain secure.

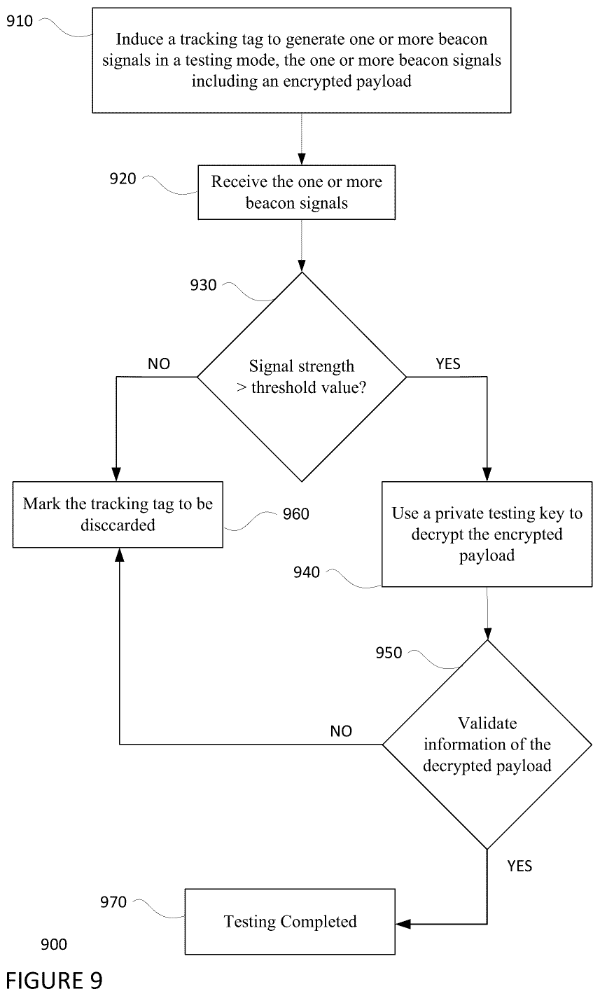

FIG. 9 is an example flow diagram 900 depicting an example method for end of line testing for a tracking tag, such as a tracking tag 500, arranged on a liner material, such as liner material 560 and moving through the testing system 700 as described above. At block 910, a tracking tag is induced to generate one or more beacon signals in a testing mode. As noted above, this testing mode may be different from a normal operation mode for the tracking tag. The one or more beacon signals may include information. As noted above, the activation unit 740 may induce the tracking tag 500 into generating the one or more beacon signals in a testing mode. In response, the tracking tag 500 may generate the one or more beacon signals including information such as an encrypted payload or an unencrypted payload.

During the manufacturing process, before the top layer 510 (and or bottom layer 550) are applied to the flex inlay, information may be encoded into the beacon transmission circuitry 520. For example, as described above, a first encryption key along with a tracking tag identifier (e.g., an identifying code or numerical value for the tracking tag) may be encoded via the manufacturing computing device during the manufacturing process. In addition to the first encryption key and the tracking tag identifier, a second encryption key may also be encoded on each tracking tag during the manufacturing process by the manufacturing computing device. The second encryption key may be a testing or manufacturing key which can be used by the tracking tags and testing system 700 for encrypting and decrypting payloads for testing purposes. In this regard, only the second encryption key may be sent by the manufacturing computing device or the another secure computing device to the testing system 700 for testing purposes. In this regard, the testing system 700 may store the second testing key in the memory of the computing devices 710 but need not have access to any of the first encryption keys of the tracking tags to be tested.

In some instances, the second encryption key may be periodically updated. For example, different second encryption keys may be used and changed hourly, daily, weekly, etc.

In this example, when the tracking tag is activated and sending beacon signals in the testing mode (as compared to the normal operation mode), the processor 540 may use the second encryption key, rather than the first encryption key, to encrypt a payload for the tracking tag. As noted above, the first encryption key may be used by a tracking tag to encrypt a payload when the tracking tag is operating in the normal operating mode. The payload may include information, such as for example, the aforementioned tracking tag identifier, general purpose states indicating whether the tracking tag is activated or in some cases activated but in a testing mode, as well as other information about the tracking tag including sensor data, such as battery voltage and temperature if the tracking tag includes a temperature sensor. The processor 540 may then use the beacon transmission circuitry to send the beacon signal with the encrypted payload.

The testing mode may be used to generate a finite and predetermined number of beacon signals for testing purposes as discussed above. In some instances, a tracking tag may be caused to enter the testing mode for a predetermined period of time in order to send such beacon signals. Once the predetermined number of beacon signals have been generated and/or the predetermined period of time has passed, the tracking tag may revert from the testing mode back to the sleep or dormant mode. In addition, as noted above, when operating the testing mode, the beacon transmission circuitry 520 to transmit beacon signals at a higher rate than when in the normal operation mode for tracking in order to ensure that the beacon signals are captured by the testing system.

As noted above, a plurality of different approaches may be used to cause a tracking tag, such as tracking tag 500, to enter into the test mode and to generate the aforementioned beacon signals at the desired testing rate. Referring to FIG. 7, the activation unit 740 may include any of the various features described above, such as a temperature sensor, a near field communication chip, an energy harvesting antenna, a contact switch, exposed contacts, and a circuit which extends beyond an outer perimeter of the tracking tag, in order to activate the tracking tag in the testing mode as described above.

At block 920, the one or more beacon signals including the information are received. The beacon signals may be captured via the reader 750.

At block 930, a signal strength of the received one or more beacon signals is compared to a threshold value. If the signal strength meets the threshold value (e.g., is greater than or equal to), the signal strength may be considered good enough for use by the end user. If the signal strength does not meet (e.g., is less than) the threshold value, the tracking tag may not be functioning properly (e.g., there may be some problem with the tracking tag) and may be marked to be discarded as shown in block 960. This marking may occur, for example, via the printer 760.

At block 940, the second encryption key is used to decrypt the encrypted payload. As noted above, the computing devices 710 of the testing system may access the stored second encryption key. The computing devices may use the second encryption key to decrypt the encrypted information.

At block 950, information of the decrypted payload is validated. For instance, if the decrypted information is valid, the tracking tag may be considered to be functioning properly and the testing is completed as shown in block 970. If the information of the decrypted payload is not validated, the tracking tag may be marked to be discarded as shown in block 960. The validation may involve analyzing the data in each section of the payload. For instance, the computing device 710 may confirm whether the tracking tag identifier is correct, whether temperature data is correct, whether the battery is above a certain voltage threshold, a checksum comparison to avoid “coincidental” false positives, etc.

Because only the second encryption key is shared with the testing system 700, this may reduce security risks of disclosure of the first encryption key. As such, the first encryption key is not needed for the testing and may remain secure.

In some instances, when the processor 540 uses the second encryption key, the payload may not actually be encrypted. In such examples, when in the testing mode, the tracking tag may send one or more beacon signals including unencrypted payloads. Accordingly, the testing system 700 need not decrypt the information in the one or more beacon signals before conducting the aforementioned comparison of the payload data.

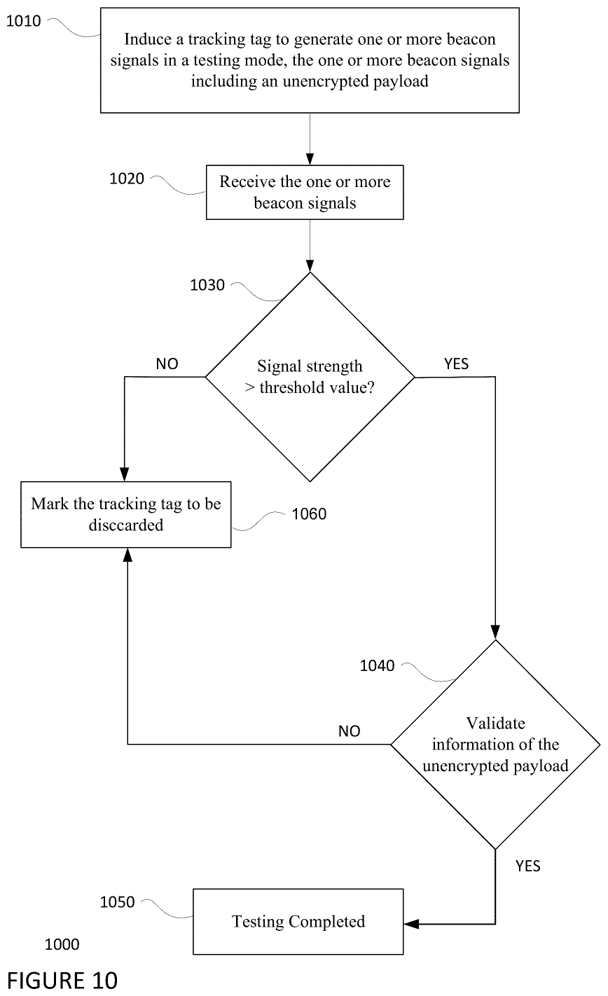

FIG. 10 is an example flow diagram 1000 depicting an example method for end of line testing for a tracking tag, such as a tracking tag 500, arranged on a liner material, such as liner material 560 and moving through the testing system 700 as described above. At block 1010, a tracking tag is induced to generate one or more beacon signals in a testing mode. As noted above, this testing mode may be different from a normal operation mode for the tracking tag. The one or more beacon signals may include information. As noted above, the activation unit 740 may induce the tracking tag 500 into generating the one or more beacon signals in the testing mode. In response, the tracking tag 500 may generate the one or more beacon signals including information in an unencrypted payload. Thus, rather than using a second encryption key, when operating in the testing mode, the tracking tag may send beacon signals without encrypting the payload using any encryption key (e.g., no first or second encryption keys are used for the testing).

During the manufacturing process, before the top layer 510 (and or bottom layer 550) are applied to the flex inlay, information may be encoded into the beacon transmission circuitry 520. For example, as described above, a first encryption key along with a tracking tag identifier (e.g., an identifying code or numerical value for the tracking tag) may be encoded via the manufacturing computing device during the manufacturing process.

In this example, when the tracking tag is activated and sending beacon signals in the testing mode (as compared to the normal operation mode), the processor 540 may need not actually to encrypt a payload for the tracking tag. As noted above, the first encryption key may be used by a tracking tag to encrypt a payload when the tracking tag is operating in the normal operating mode. The payload may include information, such as for example, the aforementioned tracking tag identifier, general purpose states indicating whether the tracking tag is activated or in some cases activated but in a testing mode, as well as other information about the tracking tag including sensor data, such as battery voltage and temperature if the tracking tag includes a temperature sensor. The processor 540 may then use the beacon transmission circuitry to send the beacon signal with the unencrypted payload.

The testing mode may be used to generate a finite and predetermined number of beacon signals for testing purposes as discussed above. In some instances, a tracking tag may be caused to enter the testing mode for a predetermined period of time in order to send such beacon signals. Once the predetermined number of beacon signals have been generated and/or the predetermined period of time has passed, the tracking tag may revert from the testing mode back to the sleep or dormant mode. In addition, as noted above, the testing mode may cause the beacon transmission circuitry 520 to transmit beacon signals at a higher rate than when in the normal operation mode for tracking in order to ensure that the beacon signals are captured by the testing system.

As noted above, a plurality of different approaches may be used to cause a tracking tag, such as tracking tag 500, to enter into the test mode and to generate the aforementioned beacon signals at the desired testing rate. Referring to FIG. 7, the activation unit 740 may include any of the various features described above, such as a temperature sensor, a near field communication chip, an energy harvesting antenna, a contact switch, exposed contacts, and a circuit which extends beyond an outer perimeter of the tracking tag, in order to activate the tracking tag in the testing mode as described above.

At block 1020, the one or more beacon signals including the information are received. The beacon signals may be captured via the reader 750).

At block 1030, a signal strength of the received one or more beacon signals is compared to a threshold value. If the signal strength meets the threshold value (e.g., is greater than or equal to), the signal strength may be considered good enough for use by the end user. If the signal strength does not meet (e.g., is less than) the threshold value, the tracking tag may not be functioning properly (e.g., there may be some problem with the tracking tag) and may be marked to be discarded as shown in block 960. This marking may occur, for example, via the printer 760.

At block 1040, the information of the unencrypted payload is validated. For instance, if the information is valid, the tracking tag may be considered to be functioning properly and the testing is completed as shown in block 1050. If the information of the unencrypted payload is not validated, the tracking tag may be marked to be discarded as shown in block 1060. The validation may involve analyzing the data in each section of the payload. For instance, the computing device 710 may confirm whether the tracking tag identifier is correct, whether temperature data is correct, whether the battery is above a certain voltage threshold, a checksum comparison to avoid “coincidental” false positives, etc.

Because only the payload does not need to be decrypted during the testing, this may reduce security risks of disclosure of the first encryption key. As such, the first encryption key is not needed for the testing and may remain secure. Accordingly, the testing system 700 need not decrypt the information in the one or more beacon signals before conducting the aforementioned comparison of the payload data.

The features described herein may provide for a safe, secure, efficient and effective way to conduct end of line testing for tracking tags. Because the encryption keys used to encrypt payloads during a normal operating mode of a tracking tag need not be shared with the testing system, this may reduce security risks of disclosure of such encryption keys. As such, these encryption keys may remain secure. In addition, the testing system provided herein may allow for a high line rate manufacturing process which adds very little or no latency as a result of the testing.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples: rather, the examples are intended to illustrate only one of many possible embodiments. Further, the same reference numbers in different drawings can identify the same as or similarly elements.

1. A system comprising:
a tracking tag having circuitry configured to:
operate the tracking tag in a normal operating mode for sending first beacon signals to enable the tracking of objects; and
operate the tracking tag in a testing mode for sending second beacon signals to enable testing of the tracking tag.

2. The system of claim 1, wherein the circuitry is configured to use a first encryption key for encrypting payloads when operating in the normal operation mode and to use a second encryption key to encrypt payloads of the second beacon signals when operating in the testing mode, the first encryption key being different from the second encryption key.

3. The system of claim 1, wherein the circuitry is further configured to use a first encryption key to generate an encrypted payload when operating the tracking tag in the testing mode, and wherein the circuitry is further configured to use the first encryption key to generate a second encrypted payload when operating the tracking tag in the normal operation mode.

4. The system of claim 1, wherein the circuitry is configured to use a first encryption key for encrypting payloads of the first beacon signals when operating in the normal operation mode and not to encrypt payloads of the second beacon signals when operating in the testing mode.

5. The system of claim 1, further comprising:
a reader including an antenna configured to receive one or more of the first beacon signals; and
one or more computing devices having one or more processors and being in communication with the reader, the one or more computing devices being configured to:
induce the tracking tag to generate the second beacon signals in the testing mode, and
determine whether to mark the tracking tag to be discarded.

6. The system of claim 5, further comprising a printer configured to mark the tracking tag to be discarded.

7. The system of claim 5, wherein the one or more computing devices are configured to induce the tracking tag further by using an activation unit including a heat source which generates heat in order to cause a temperature sensor in the tracking tag to engage the testing mode.

8. The system of claim 5, wherein the one or more computing devices are configured to induce the tracking tag further by using an activation unit including a near field communication coil which is configured to communicate with the tracking tag using near field communication in order to engage the testing mode.

9. The system of claim 5, wherein the one or more computing devices are configured to induce the tracking tag further by using an activation unit including a radio frequency illuminator which is configured to send a signal to an energy harvesting antenna of the tracking tag in order to engage the testing mode.

10. The system of claim 5, wherein the one or more computing devices are configured to induce the tracking tag further by using an activation unit including hardware to activate a contact switch of the tracking tag in order to engage the testing mode.

11. The system of claim 5, wherein the one or more computing devices are configured to induce the tracking tag further by using an activation unit including hardware to bridge exposed contacts of the tracking tag in order to engage the testing mode.

12. The system of claim 5, wherein the one or more computing devices are configured to induce the tracking tag further by using an activation unit including hardware that engages with a circuit that extends beyond a perimeter of the tracking tag in order to engage the testing mode, and wherein the computing devices are further configured to remove a portion of the circuit that extends beyond a perimeter after engaging the testing mode.

13. The system of claim 5, wherein the circuitry is further configured to encrypt a payload of the first beacon signal using a first encryption key, and the one or more computing devices are further configured to:
access a plurality of pre-stored encrypted payloads for the tracking tag; and
compare the encrypted payload to the plurality of pre-stored encrypted payloads, and to determine whether to mark the tracking tag to be discarded further based on the comparison.

14. The system of claim 13, wherein the one or more processors are further configured to mark the tracking tag to be discarded based on whether the encrypted payload matches one of the plurality of pre-stored encrypted payloads.

15. The system of claim 13, wherein the one or more computing devices are further configured to generate the plurality of pre-stored encrypted payloads prior to inducing the tracking tag.

16. The system of claim 5, wherein the circuitry is configured to use a first encryption key for encrypting payloads when operating in the normal operation mode and to use a second encryption key to encrypt payloads of the second beacon signals when operating in the testing mode, the first encryption key being different from the second encryption key, and the one or more computing devices are further configured to:
decrypt the encrypted payload using the second encryption key; and
validate information of the decrypted payload, and to determine whether to mark the tracking tag to be discarded further based on the validation.

17. The system of claim 5, wherein the circuitry is configured to use a first encryption key for encrypting payloads of the first beacon signals when operating in the normal operation mode and not to encrypt payloads of the second beacon signals when operating in the testing mode, and the one or more computing devices are further configured to validate information of the unencrypted payload, and to determine whether to mark the tracking tag to be discarded further based on the validation.

18. The system of claim 5, further comprising a plurality of tracking tags arranged on a roll with the tracking tag.

19. The system of claim 18, further comprising a conveyor, a first spooling device on which the roll is arranged and a second spooling device on which a second roll is arranged, and one or more control units configured to rotate the first spooling device and the second spooling device at a desired rate of speed to move the tracking tag from the roll to the second roll and enable testing of the tracking tag.

20. The system of claim 19, wherein the reader is positioned to receive the first beacon signal when the tracking tag is between the roll and the second roll.
